(19) United States
(12) Patent Application Publication
(10) Pub. No.: US 2006/0042356 A1
(43) Pub. Date: Mar. 2, 2006

(54) Measuring soil permeability in situ

(76) Inventor: R. Robert Goughnour, Leesburg, VA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/213,078

(22) Filed: Aug. 26, 2005

Related U.S. Application Data
(60) Provisional application No. 60/605,980, filed on Aug. 31, 2004.

(51) Int. Cl. G01N 15/08

(52) U.S. Cl. 73/38

(57) ABSTRACT

Soil permeability is measured in situ by connecting an elongated fluid supply tube to a section of prefabricated vertical drain for remote fluid communication with interior portions of the drain. The combination drain with attached tube is then installed into the soil at a predetermined level below the soil surface with a proximal end of the tube exposed above the soil surface. The tube is then filled with water and the hydraulic conductivity of water in the tube and drain section combination is measured versus time for thereby measuring the soil permeability in situ.

### BACKGROUND OF THE INVENTION

This invention relates generally to soil improvement, and more particularly to improvements in determining soil permeability, or hydraulic conductivity, as it relates to the installation and operation of vertical prefabricated drains used for consolidation acceleration, liquefaction mitigation, remediation and contaminant removal.

When loads are placed on the surface of soft, saturated clay deposits, large settlements often result because of compression of the clay material. In saturated material, this settlement can take place only as pore water is expelled. If the permeability (hydraulic conductivity) of the compressible soil is very low, this process takes place very slowly. Total settlements of several meters are common and often take years to occur. This time-dependent process is called consolidation. A process called sand drains and surcharging has been used in these cases since the 1920's (See D. E. Moran, U.S. Pat. No. 1,598,300).

In this process sand drains (columns of sand) are installed vertically on a regular area pattern through the soft layer to be treated. After the sand drains are installed, a sand or gravel drainage blanket one to three feet thick is placed over the drains to permit water to flow out of the drains. An earth embankment is placed over this drainage blanket. The thickness of the embankment or surcharge is normally calculated to produce loading roughly 10% greater than the anticipated final design load planned for the project.

The sand drains now provide free drainage paths within the clay mass. Without drains, drainage from any point within the clay must take place vertically, either to the surface or downward to a permeable soil layer below, if such layer is present. With drains present, the drainage distance from any point within the clay is to the nearest drain. Drains are spaced so that drainage paths are much shortened, and consolidation occurs much more rapidly. The surcharge is left in place until the consolidation process is nearly complete (commonly about 90% under the surcharge load). This creates a condition where the soil skeleton (or soil grain network) is loaded to a level approximately equal to or somewhat greater than the anticipated design load. The surcharge is then removed and the project proceeds. Since the soft skeleton has been precompressed to a load somewhat greater than the design load, no further settlement occurs as a result of consolidation.

In the late 1960's and early 1970's, wick drains were developed as an alternative to sand drains. Wick drains are not truly wicks, but are composite drains composed of an extruded plastic core, shaped to provide drainage channels when the core is wrapped in a special filter fabric. See for example U.S. Pat. No. 5,820,296. The filter fabric (geofabric or geotextile) acts as a filter, constructed with opening sizes, which prevent the entrance of soil particles, but allow pore water to enter freely. The finished wick material is band-shaped, about ⅛ to ¼ inches thick and approximately 4 inches wide. It is provided in rolls containing 800 to 1000 feet of drain. An example manufacturer is Nilex Corporation of Centennial, Colo., U.S.A. Its product is sold under the trade name MEBRADRAIN. Such wick drains are often referred to as prefabricated vertical drains or PV drains.

The design of a prefabricated vertical drain system depends on the loading conditions imposed on the soil and on the time available for consolidation to take place. The most important soil parameters required for such a design are the soil compressibility and the soil permeability. Conventionally these parameters are determined from standard consolidation tests taken on soil samples. Such samples are obtained by techniques that disturb or remold the soil to the least extent possible. In this test a small, “undisturbed” soil sample is subjected to incremental vertical loading in the laboratory. The test is arranged so that the sample can drain freely in a vertical direction only. Each vertical load increment is allowed to stay in place until consolidation is complete while deformation is measured as a function of time. Soil compressibility resulting from vertical load and vertical permeability are back calculated from these results.

There are a number of shortcomings associated with this procedure when applied to wick drain installations:

1. Soil is more often than not very heterogeneous and the sample taken may not faithfully represent the gross characteristics of the soil.

2. Laboratory consolidation tests enforce vertical compression along with vertical drainage which faithfully simulates field consolidation for cases where no drains are present. This also simulates field compression for wick drain sites, but drainage on these sites is predominately horizontal (radial) to the drain. Horizontal permeability is typically greater than the vertical permeability. The ratio of horizontal to vertical permeability may range from unity to an order of magnitude or more. Determining horizontal permeability in the laboratory involves expensive, nonstandard tests, which are rarely performed. In most cases the horizontal permeability used for design is estimated based on historic values of the ratio of horizontal to vertical permeability, or may be based on experience with soil in a particular area.

3. The physical act of installing the drain into the soil within a mandrel remolds the soil for some distance around the drain. Such remolding can significantly affect soil permeability in the remolded area. Attempts have been made to quantify this effect and correlate it with the laboratory-determined permeability; these have not been completely satisfactory.

4. Consolidation tests are expensive and time-consuming.

### SUMMARY OF THE INVENTION

The present invention provides a method for measuring soil permeability in situ. In accordance with the teachings of the present invention an elongated fluid supply tube is connected to a section of prefabricated vertical drain of known length for remote fluid communication with interior portions of the drain. The section of drain is then installed to a predetermined depth into the soil with present day known methods of installation. A proximal end of the connected tube extends to and is exposed above the soil surface. The tube is then filled with water and the hydraulic conductivity of water through the tube and drain section and subsequently into the soil surrounding the drain is measured versus time for thereby measuring the soil permeability in situ.

In calculating the soil permeability, the equilibrium water level also needs to be known. The equilibrium water level is measured by inserting a water level probe down the tube initially before it is filled.

Measurement of the hydraulic conductivity of the soil may be carried out by a number of methods. One is a constant head test wherein measuring the hydraulic conductivity is carried out by connecting the filled tube to a constant head water source having metering capability and the flow of water into the section of drain versus time is measured for thereby measuring the soil permeability. In this method, the tube may be closed off below the equilibrium water level prior to the step of filling and thereafter reopened to thereby start the flow of water from the source into the drain.

A second method of measuring the hydraulic conductivity is carried out by measuring the fall of the water level in the tube versus time for thereby measuring the soil permeability.

Installation of the section of drain and tube combination is generally carried out by intruding the section of drain with the attached tube into the soil with a surrounding mandrel as taught for example in U.S. Pat. No. 5,213,449, which teaches standard installation of prefabricated vertical drains. Thereafter the mandrel is withdrawn. In accordance with the teachings of the present invention, passages in the soil which may be left by removal of the mandrel may be sealed off for thereby preventing preferred drain passages in the soil prior to measuring the permeability.

It is also desirable to purge any air from the water filled tube prior to measuring the hydraulic conductivity.

### BRIEF DESCRIPTION OF THE DRAWINGS

Other objects and advantages appear hereinafter in the following description and claims. The accompanying drawings show, for the purpose of exemplification, without limiting the scope of the invention or the appended claims, certain practical embodiments of the present invention wherein:

FIG. 1 is a schematic diagram illustrating the method of the present invention using constant head measuring techniques; and

FIG. 2 is a schematic diagram illustrating the method of the present invention using falling head measuring techniques for measuring the permeability.

### DESCRIPTION OF PREFERRED EMBODIMENTS

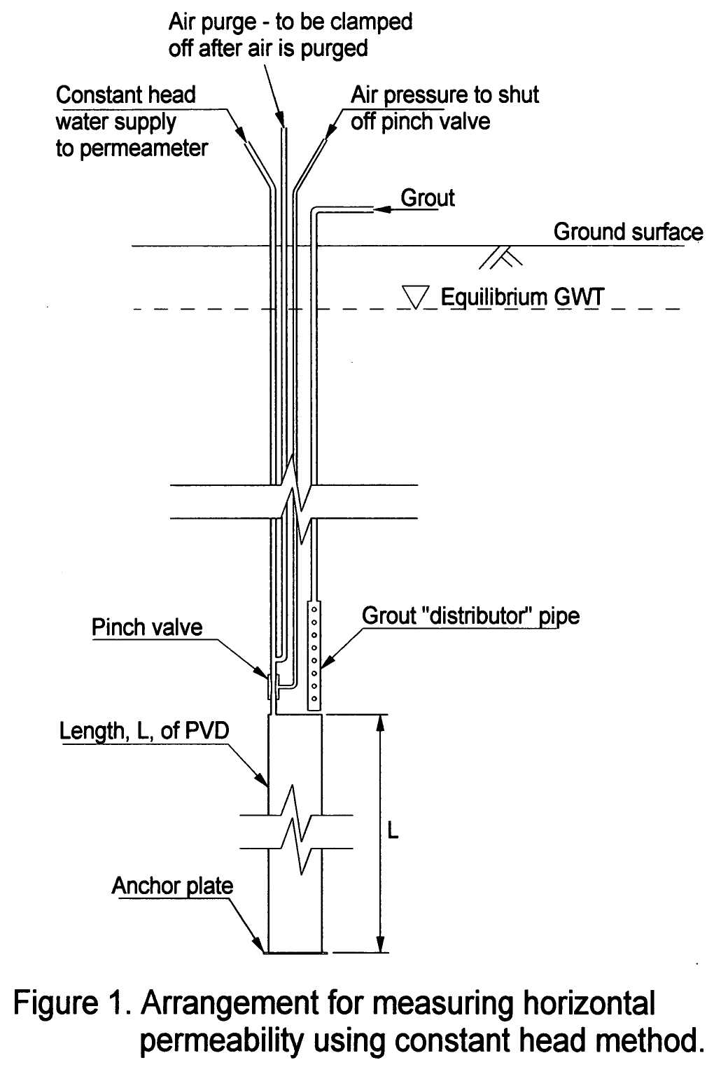

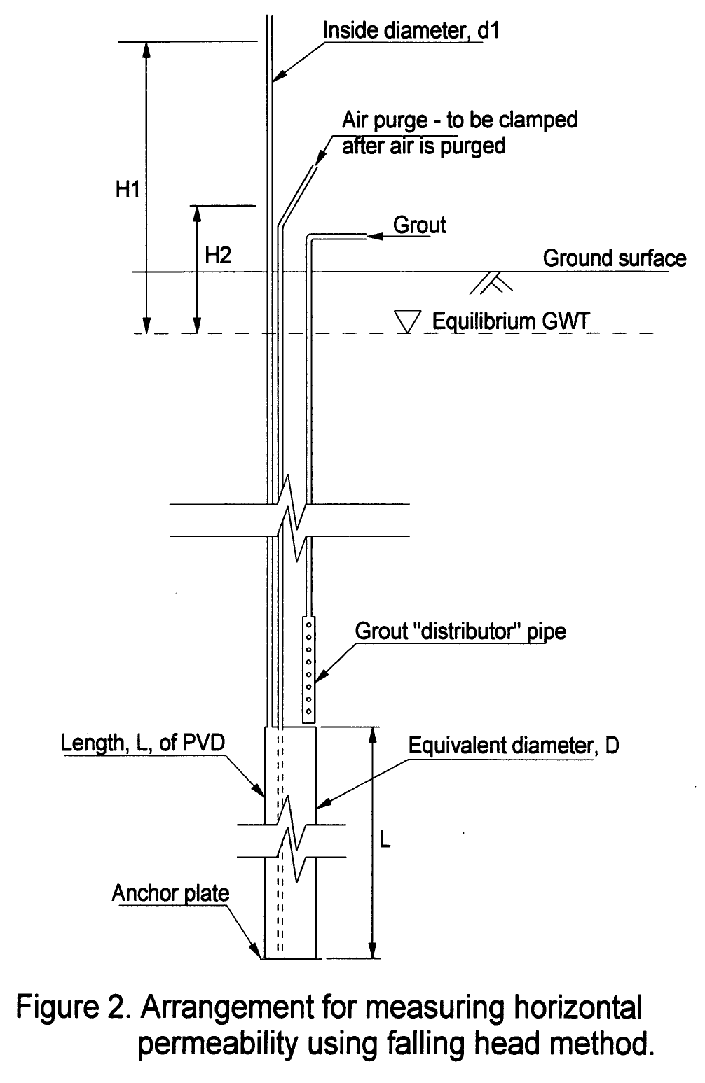

Presented here is a method that provides a measure of soil permeability in situ, and under installation and operating conditions, as they will exist for actual wick drain installations. The test apparatus consists of a length of wick drain material embedded in the ground at the depth under consideration. Tubes and pipes extend from the drain to the ground surface (see FIGS. 1 and 2).

This assembly is installed in the ground with the drain installation rig, using the same mandrel, anchor plate and installation procedures as will be used on the actual project. The drain test assembly is inserted into the mandrel on the installation rig with the anchor plate attached to the PV drain. The anchor plate will serve to cover the bottom of the mandrel preventing soil from entering the mandrel during penetration, and will anchor the test drain in place. The mandrel is then intruded by the machine into the ground to the desired depth, and withdrawn leaving the length, L, of wick drain anchored in place within the soil, with the tubes and pipes extending to the ground surface.

The cross sectional area of the mandrel is greater than the cross sectional area of the combined tubes and pipes. Although the soft soil material will squeeze into this void left by mandrel withdrawal, there may be a preferred drainage path created. One tube or pipe may be provided to deliver grout to the area above the section of wick drain to “cut off” this potential preferred drainage path. Grouting may not be necessary in all cases. The remaining tubes and pipes extending to the surface provide access to the section of drain to supply or withdraw water while measuring the pressure response within the drain section.

Although many types of tests may be devised which pump a measured amount of water into the drain as well as tests which remove a measured amount water from the drain, there are some standardized tests conventionally used with packers in a borehole that are attractive for adaptation to use with this apparatus. Some of these tests with appropriate equations are described by Hvorslev (“Time Lag and Soil Permeability in Ground Water Observations”, Bulletin No. 36, Waterways Experiment Station, Corps of Engineers, U.S. Army). Two in particular are of interest, the constant head test and the falling head test.

FIG. 1 illustrates the arrangement for application of a constant head test. The steps to perform a constant head test are in general:

1. Assemble test drain unit, load into installation mandrel, and install test drain to the desired depth.

2. Attach grout supply and pump a measured amount of grout to cut off potential preferred drainage path above the test drain length.

3. Allow time for grout reaction to go to completion, and for water level to stabilize to equilibrium conditions.

4. After equilibrium is achieved measure equilibrium water level by inserting a water level probe down the water supply pipe.

5. Apply pressure to the pinch valve to shut off flow to the section of PV drain.

6. Purge air from lines by pumping water down the purge tube until no air bubbles are seen coming from the water supply pipe.

7. Clamp off the purge tube.

8. Connect the water supply pipe to a constant head water source with metering capability.

9. Release air from the pinch valve to start flow of water into the PV drain. This is time zero for the test.

10. Take readings of water flow versus time.

A description of a rudimentary field test along with an example of the appropriate calculations is given by Welker, A. L., Devine, B. J., Goughnour, R. R., and Foster, J. (“Measurement of In-situ Hydraulic Conductivity and Coefficient of Consolidation using Prefabricated Vertical Drains,” Proceedings of the 83^{rd} Annual Meeting of the Transportation Research Board, Washington, D.C., Jan. 11-15, 2004. The procedure outlined above is a refined version utilizing experience gained from this test.

FIG. 2 illustrates the arrangement required for the falling head test. Installation of the PV test drain, grouting procedures, and measurement of the equilibrium water level are the same as for the constant head test. Air is purged from the system by pumping water down the indicated tube until no air bubbles emerge from tube indicated with inside diameter d1. The purge tube is then clamped.

To begin the actual test the purge tube is left clamped and the second tube is filled with water to some level greater than H1 as indicated on FIG. 2. The pressure thus applied to the water within the system will have only one escape path. This escape path is through the length, L, of drain within the soil. As water flows from the length of wick drain, the water surface visible within the plastic tube will fall. The time for this water surface to fall some measured distance (H1-H2) is determined. With this data the horizontal permeability can be determined by using equations presented by Hvorslev.

Actually, Hvorslev's equations require the assumption of some value for the ratio of horizontal permeability to vertical permeability, along with the data from this test. However, the computed horizontal permeability is very insensitive to this assumed ratio, and any reasonable value will produce very accurate results. Further, the vertical compressibility will generally be obtained from conventional laboratory consolidation tests. Vertical permeability will be available from these tests.

It is apparent that additional test procedures will be developed in the future. A test that removes water from the drain would be of particular interest since this is the direction of flow in actual drain operation. Further research will be required to validate test results with field performance.

Of more serious consequence is the fact that the equations are also based on the assumption that the soil is homogeneous, and that permeability within the soil is everywhere the same. In reality the soil adjacent to the drain will have been remolded by the installation process and the permeability of this remolded soil will generally be lower than that further from the drain. This effect is generally referred to as smear. The permeability measured by the test will be an average of that within some distance from the drain. This distance will depend on the length, L, and would be assumed to obtain an average horizontal permeability, including smear effects, for the appropriate soil mass. This assumption will, of course, also need to be validated by actual field experience.

I claim:

1. A method for measuring soil permeability in situ comprising:
connecting an elongated fluid supply tube to a section of prefabricated vertical drain for remote fluid communication with interior portions of said drain;
installing said section of drain into the soil at a predetermined level below the soil surface with a proximal end of said connected tube exposed above the soil surface;
filling said tube with water; and
measuring the hydraulic conductivity of water through the tube and drain section combination versus time for thereby measuring the soil permeability in situ.

2. The method of claim 1, including the step of measuring the equilibrium water level in said tube prior to the step of filling by inserting a water level probe down said tube.

3. The method of claim 2, wherein the step of measuring the hydraulic conductivity is carried out by connecting said filled tube to a constant head water source having metering capability, and measuring the flow of water into said section of drain versus time for thereby measuring the soil permeability.

4. The method of claim 3, including closing said tube off below the equilibrium water level prior to the step of filling and thereafter reopening said tube to thereby start the flow of water from said source into said drain.

5. The method of claim 3, wherein the step of installing is carried out by intruding the section of drain and attached tube into the soil with a surrounding mandrel, and thereafter withdrawing the mandrel.

6. The method of claim 5, including the step of sealing off passages in the soil left by removal of the mandrel for thereby preventing preferred drain passages in the soil.

7. The method of claim 6, wherein the step of sealing off is accomplished by injecting grout into said passages.

8. The method of claim 2, wherein the step of measuring the hydraulic conductivity is carried out by measuring the fall of the water level in said tube versus time for thereby measuring the soil permeability.

9. The method of claim 8, wherein the step of installing is carried out by intruding the section of drain and attached tube into the soil with a surrounding mandrel, and thereafter withdrawing the mandrel.

10. The method of claim 9, including the step of sealing off passages in the soil left by removal of the mandrel for thereby preventing preferred drain passages in the soil prior to measuring the permeability.

11. The method of claim 10, wherein the step of sealing off is accomplished by injecting grout into said passages.

12. The method of claim 1, including the step of purging said filled tube of air prior to measuring the hydraulic conductivity.
